(19) United States
(12) Patent Application Publication
(10) Pub. No.: US 2004/0010458 A1
(43) Pub. Date: Jan. 15, 2004

(54) Methods and systems for organizing information from multiple sources

(75) Inventor: Brian Friedman, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO

(21) Appl. No.: 10/193,722

(22) Filed: Jul. 10, 2002

(51) Int. Cl. G06F 17/60

(52) U.S. Cl. 705/35

(57) ABSTRACT

A method and system for managing information are provided. Financial-transaction data collected from multiple distinct sources is maintained, with each of the sources providing financial-transaction data associated with multiple financial-service providers. One of the financial-service providers submits a query, which may be one of several available preformatted queries or which may be constructed individually by the financial-service provider. A response to the query is generated, including correlating financial-transaction data from the distinct sources. The response is then transmitted to the financial-service provider submitting the query.

### BACKGROUND OF THE INVENTION

This application relates generally to financial transactions. More specifically, this application relates to methods and systems for managing information that is generated or accumulated in connection with financial transactions.

In the last several decades, there has been a steady increase in the sophistication of financial transactions, both in terms of the type of transactions that are possible by consumers and in terms of how those transactions are processed. Much of this increase in complexity may be attributed to improvements in communications infrastructures that permit near-instantaneous access to data regarding individual customers. The credit-card industry provides a simple illustration. Several years ago, credit-card transactions would proceed at a merchant by having a customer present his card, from which an imprint was taken. A physical copy of the imprint would be forwarded to the credit issuer, who would seek to recover payment from the consumer with a monthly bill. Occasionally, if the transaction was large, perhaps as defined in accordance with a guideline from the credit issuer, a telephone call might be placed to the credit issuer at the time of the transaction to receive authorization in advance. Because seeking authorization by telephone was slow, authorization for transactions was often not obtained in advance, leading to a significant possibility of fraud. Moreover, transaction records were generally maintained in nonelectronic forms, making them unwieldy and not readily amenable to analysis for patterns.

The development of improved communication methods between merchants and credit issuers, without the need for involving a human representative, has resulted in virtually every credit-card transaction being authorized before execution. Information regarding the proposed transaction is communicated electronically for approval, where it is evaluated through an automated mechanism for near-instantaneous communication back to the merchant. In addition, computerized facilities have become the norm in other aspects of credit-card transactions, including in such areas as performing credit checks on new customers, creating solicitations for new customers, performing customer-service functions for new customers, and performing collections functions, among others. Each of these activities generates potentially useful information regarding credit-card customers, although the specific character of the information may depend on the particular nature of each activity.

Similar developments have taken place with respect to other types of financial transactions, such as money-transfer functions, the development of customer loyalty programs, etc. In these and other financial areas, significant volumes of information are generated that may be useful to individual financial-service providers for analyzing the acceptance of their services by customers, their market share and how it is affected by certain policies, their profitability, etc. Accordingly, this application is directed to methods and systems for organizing such information when it is provided from multiple sources.

### BRIEF SUMMARY OF THE INVENTION

Embodiments of the invention thus provide a method and system for managing information that may be collected from a plurality of distinct sources of financial-transaction data. A database is provided that maintains information received from each of the plurality of distinct sources so that it may be accessed as desired to provide responses to queries. In some embodiments, the queries are generated by selecting entries from fields that represent portions of the database. In some instances, the available fields may be limited by data model that restricts the fields for generating the query according to certain specified criteria. In other embodiments, the queries are selected from a menu of preformatted queries by a user. The generation or selection of the queries may be performed with a web Internet interface, from which they are transmitted so that relevant data may be retrieved from the database. In some embodiments, the query may identify one or more predetermined times for execution.

In one set of embodiments, data collected from the plurality of distinct sources is thus maintained, with each of the sources providing financial-transaction data associated with a plurality of financial-service providers. One of the financial-service providers submits a query, from which a response is generated, including correlating financial-transaction data from at least two of the distinct sources. The response is returned to one of the sources so that further action may be taken in accordance with the result. The query may be one of an audit-based query, a marketing-based query, and a risk-based query, among other possible types of queries.

In another set of embodiments, data collected from the plurality of distinct sources is also maintained, with each of the sources providing financial-transaction data associated with a plurality of financial-service providers. One of the financial-service providers submits a query that specifies a simulation. A result of the simulation is returned to the financial-service provider. As before, the query may be an audit-based query, a marketing-based query, and a risk-based query, among other possible types of queries.

The methods of the present invention may be embodied in a computer-readable storage medium having a computer-readable program embodied therein for directing operation of a computer system. Such a computer system may include a communications device, a processor, and a storage device. The computer-readable program includes instructions for operating the computer system to manage information in accordance with the embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1A is a schematic diagram illustrating how financial-transaction information may be collected from multiple sources;

FIG. 1B is a schematic diagram showing a structural arrangement of a system in accordance with an embodiment of the invention;

FIG. 2 is a schematic illustration of a configuration of a computer system on which methods of the invention may be embodied;

FIG. 3 is a flow diagram illustrating several embodiments of the invention; and

FIGS. 4A-4E are exemplary screen shots that may be accessed by a user in accordance with embodiments of the invention.

### DETAILED DESCRIPTION OF THE INVENTION

Embodiments of the invention provide a method and system for managing information that comprises financial-transaction data collected from a plurality of distinct sources. In other embodiments, the financial-transaction data may be collect from a single source. As used herein, the term “financial-transaction data” is intended to be interpreted broadly as including any data relevant to a financial transaction, whether or not that data is actually used in the transaction. Examples include data that is related directly to specific financial transactions, such as the identities of an individual and merchant participating in the transaction, the subject matter of the transaction, the amount of the transaction, etc. In addition, other examples include data that is related indirectly to financial transactions, such as the identity of individuals with credit accounts, their credit limits, the address to which periodic statements are to be sent, their past purchasing habits, demographic information that may be used to classify financial transactions, etc.

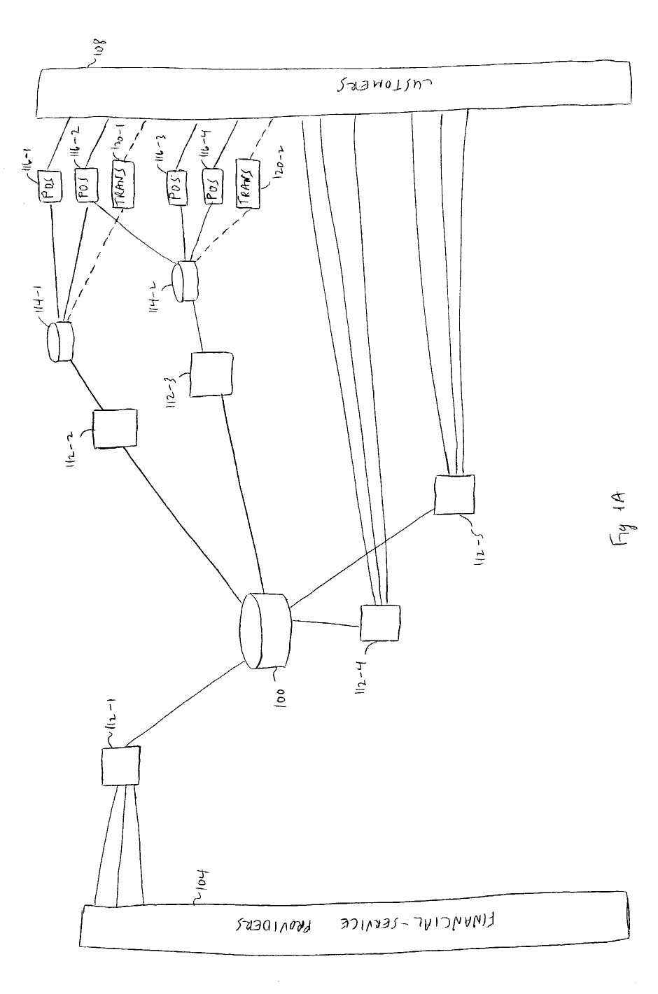

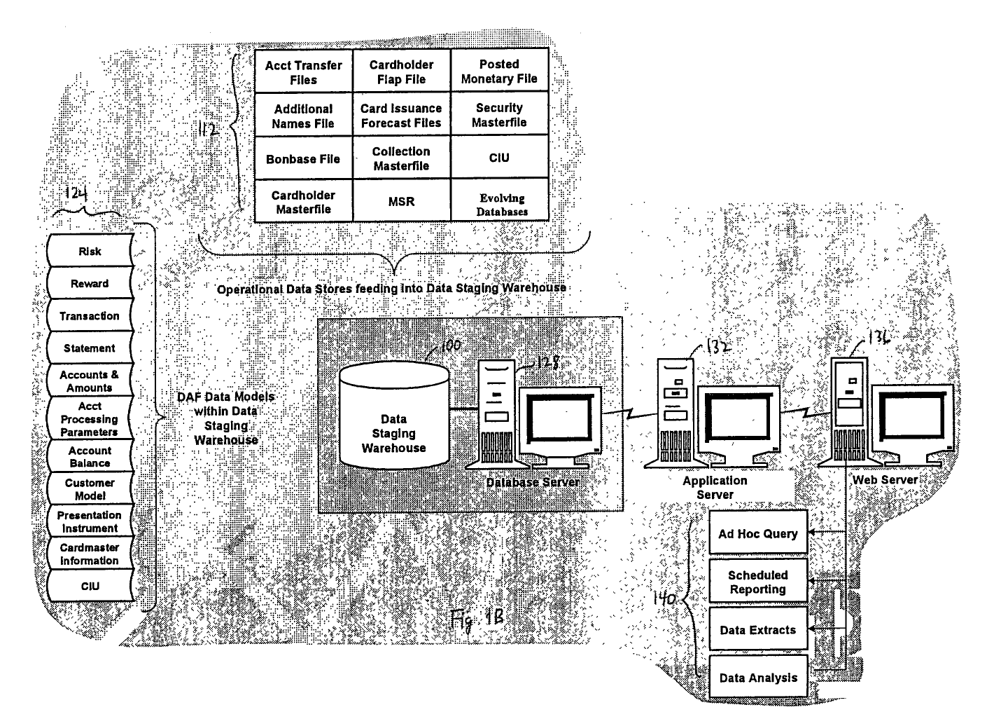

FIG. 1 shows an exemplary structure that illustrates how financial-transaction data may be collected from a plurality of distinct sources 112 of such data. The structure is used to collect the information without impeding the financial services provided to customers 108 by financial-service providers 104. The financial-service providers 104 may include such entities as banks, credit unions, credit-card issuers, prepaid-card issuers, debit-card issuers, money-order issuers, etc. In addition, it is also possible for some of the financial-service providers 104 to be principally engaged in another business, provided they additionally offer at least some financial services. For example, a retail organization may provide its customers a credit card for use in its stores; while the principal business of the organization is retail sales, it is considered to be a financial-service provider according to the definition used herein because it additionally offers such a credit service.

The customers 108 may broadly include any individuals and/or entities that use, or have the potential to use, the financial services provided by one or more of the financial-service providers 104. Collected financial-transaction data is stored in one or more databases 100 that are in communication with the distinct financial-transaction-data sources 112. FIG. 1 shows some possible communications paths between the customers 108, financial-service providers 104, and database 100 to illustrate the manner in which the financial-transaction data may be collected. It will be appreciated, however, that various other communications paths may exist both among the illustrated components and with other components not shown in the figure to effect various related functions.

Examples are shown in the illustration of different mechanisms by which the financial-transaction data may be collected. For example, in one embodiment, direct financial-transaction data is collected in the context of specific transactions with sources 112-2 and 112-3. Such sources 112 may interact with operational data stores 114, which are generally distinct from the sources 112, but may alternatively be integrated with the sources 112. It is generally contemplated that such sources will each comprise a system for automatically receiving data from the operational data stores, but the invention may more generally include any arrangement that provides the financial-transaction data to the database 100. For example, financial-transaction-data sources 112-2 and 112-3 may comprise routers or servers that are used for collecting data from the operational data stores 114 after that data has been communicated from point-of-sale devices 116. Such point-of-sale devices may be simple devices known in the art for collecting credit-card and transaction-amount information or may be more functionally versatile devices that accommodate a variety of different types of financial transactions. Examples of point-of-sale devices that include multiple capabilities are provided in the following commonly assigned applications, the entire disclosures of which are incorporated herein by reference for all purposes: U.S. Prov. Pat. Appl. No. 60/147,889, entitled “INTEGRATED POINT OF SALE DEVICE,” filed Aug. 9, 1999 by Randy J. Templeton et al.; U.S. pat. appl. Ser. No. 09/634,901, entitled “POINT OF SALE PAYMENT SYSTEM,” filed Aug. 9, 2000 by Randy J. Templeton et al.; U.S. pat. appl. Ser. No. 10/116,689, entitled “SYSTEMS AND METHODS FOR PERFORMING TRANSACTIONS AT A POINT-OF-SALE,” filed Apr. 3, 2002 by Earney Stoutenburg et al.; U.S. pat. appl. Ser. No. 10/116,733, entitled “SYSTEMS AND METHODS FOR DEPLOYING A POINT-OF-SALE SYSTEM,” filed Apr. 3, 2002 by Earney Stoutenburg et al.; U.S. pat. appl. Ser. No. 10/116,686, entitled “SYSTEMS AND METHODS FOR UTILIZING A POINT-OF-SALE SYSTEM,” filed Apr. 3, 2002 by Earney Stoutenburg et al.; and U.S. pat. appl. Ser. No. 10/116,735, entitled “SYSTEMS AND METHODS FOR CONFIGURING A POINT-OF-SALE SYSTEM,” filed Apr. 3, 2002 by Earney Stoutenburg.

Upon execution of a transaction that uses a point-of-sale device 116, financial-transaction data may be communicated from the point-of-sale device 116 to one of the sources 112, which then acts to approve or deny the transaction. Information regarding the transaction is communicated to the database 100 from the source 112. In some embodiments, individual point-of-sale devices (such as device 116-2) may be configured to communicate with multiple financial-transaction-data sources 112, but in other embodiments, individual point-of-sale devices (such as device 116-3) may be in communication with only a single source.

In other embodiments, nonelectronic transactions 120 may still provide financial-transaction data. In such instances, the financial-transaction data are communicated to one of the financial-transaction-data sources 112 by an alternative method, such as by mail, fax, or courier. The source 112 that receives the data may then convert it into a form suitable for transmission to the database 100. For example, it may be put into electronic form by keying or scanning, among other techniques known in the art.

In other embodiments, indirect financial-transaction data may be collected, such as by financial-transaction-data sources 112-4 and 112-5. For example, source 112-4 could comprise a card-issuance unit of an organization that performs the function of issuing credit, debit, and other types of cards to customers 108 on behalf of financial-service providers 104. This financial-transaction-data source 112-4 receives information directly from the financial-service providers 104 and uses that information to prepare and mail cards to the customers 108. Further details regarding the such processes are provided for certain embodiments in the following copending, commonly assigned patent applications, the entire disclosure of each of which is herein incorporated by reference for all purposes: U.S. pat. Ser. No. 10/109,459, entitled “SYSTEM FOR CARD PROCESSING, EMBOSSING AND FULFILLMENT,” filed Mar. 26, 2002 by Sharon K. Hogan et al.; U.S. pat. Ser. No. 10/108,806, entitled “METHOD AND SYSTEM FOR PROCESSING CARD REISSUE TRANSACTIONS,” filed Mar. 26, 2002 by Rebecca Goodman et al.; and U.S. pat. Ser. No. 10/108,217, entitled “SYSTEM FOR RANKING CARD REISSUE TRANSACTIONS,” filed Mar. 26, 2002 by Jim K. Prendergast. At least some of the information received includes financial-transaction data since it is related to transactions that may be performed with the cards by the customers; this information is therefore provided to the database 100 in accordance with embodiments of the invention. For example, the information may include credit-agreement terms for each customer, including an interest rate, a credit cycle, applicable fees, etc.

Similarly, source 112-5 might comprise a collections department operated on behalf of the financial-service providers 104. For a variety of financial transactions, customers 108 send periodic payments to the collections department in any of a variety of forms, electronically, by mail, or otherwise. These payments are processed by the collections department and appropriate amounts are remitted to the respective financial-service providers. Relevant financial-transaction data that may be maintained in the database 100 therefore includes a record of the fact that certain customers made payments and the amounts that they paid compared with the amounts that were due.

Still other financial-transaction-data sources, such as source 112-1, may be configured for communication only with the financial-service providers 104 and database 100, but not directly with any of the customers 108. For example, source 112-1 might comprise a facility for maintaining records of policies for each of the financial-service providers to be implemented in connection with managing transactions. Such policies may include, for example, interest rates to be applied and how to respond to failures of customers to make timely payments. Such records fall within the scope of financial-transaction data because the policies are relevant to the manner in which individual transactions with customers are to be treated.

FIG. 1B shows a schematic overview of a structure that may be used in an embodiment to provide an interface with the database 100. The example illustrates an Internet-based interface, although other types of network-based or dedicated interfaces may alternatively be used. A financial-service provider that wishes to perform an analysis based on the data maintained in the database 100 interfaces with a web server 136 that is itself in communication with an application server 132. The application server 132 communicates with a database server 128 that performs the actual extraction of data. The application server 132 is configured to execute functions that a user from the financial-service provider may specify through the web server 136.

A number of examples are provided of the types of functions 140 that may be accessed, although a variety of additional types of applications may also be provided. For example, the web server 136 may permit the user to prepare a specialized query (labeled “Ad Hoc Query”) in which the criteria that define what data is extracted from the database 100 are defined on a case-by-case basis by the user. In some other embodiments, a query may be selected from a menu of preformatted queries. Such preformatted queries may fall into at least two classes: in one class (labeled “Data Extracts”) the query acts to retrieve specified data from the database 100 and to present the results of the data extraction; in a second class (labeled “Data Analysis”), the query further acts to perform analytical functions on the data extracted from the database 100, generally presenting the results of the analysis to the user rather than the raw data used in that analysis. In some embodiments, a mechanism (labeled “Scheduled Reporting”) is provided for allowing queries to be executed on a scheduled basis, such as weekly or monthly. Such scheduled queries may generally fall within any of the other classes of queries. For example, they may be generated uniquely by a user or may be selected from a menu of preformatted queries, and may either perform a data extraction or perform an analysis of certain data.

In some instances, application of the functions 140 may simplified by using one or more data models 124, some of which are suggested in the figure. Such data models 124 generally function to limit the selections from the database so that the sources that are being used are relevant to the information that the user is seeking. Using data models in this manner to limit the amount of information generally improves the efficiency of the user in navigating the large amounts of information that are accessible. In addition, such a limiting capability may be used so that certain individuals may be authorized to access data provided only by certain of the data models depending on the relevance of such information to their positions.

Several specific examples of data models 124 are provided in the figure that may be useful for a credit-card provider. For example, a “Risk” data model might limit the data accessible to a user to those fields related to risk, such as credit scores for individual customers, scores defining the risk that cards may be used to purchase certain types of merchandise fraudulently, etc. A “Reward” data model might similarly limit the accessible data to fields related to bonus rewards for using a credit card. A “Transaction” data model might limit data to fields related to transactions with credit cards, including the types of transactions that are available to customers. A “Statement” data model might be provided to limit data to fields related to customer billing statements. An “Accounts & Amounts” data model might limit data to fields related to individual customer accounts, including outstanding balances on those accounts. A “Acct Processing Parameters” data model might limit data to fields defining how accounts are processed internally. An “Account Balance” data model might be a particularly restrictive model that limits to fields defining balances of individual credit accounts. A “Customer Model” data model might limit data to fields defining demographic characteristics of customers, their credit and bankruptcy scores, etc. A “Presentation Instrument” data model might limit data to fields related to the types of instruments that may be presented in credit-card transactions. A “Cardmaster Information” data model might limit data to fields related to the characteristics of each of the credit accounts, such as interest rate, cycle time, applicable fees, etc. A “CIU” data model might limit data to fields related to the processes of issuing cards to individual customers. These examples of specific data models are provided for illustrative purposes only and are not intended to limit the scope of the invention.

In alternative embodiments, the data models may be more sophisticated so that not only are the accessible fields limited, but also provide algorithms for simulating how future data is expected to respond to changes in parameters. Such simulation data models 124 may use analytical, statistical, or other techniques for determining correlations between different types of data or for determining the effect of specified parameters. In some instances, data accessed in executing such a data model 124 may correspond only to data collected for the particular financial-service provider making the request. In other embodiments, the data used in executing the data model may include information obtained for multiple financial-service providers, allowing the model to benefit from a larger cross-section of information.

For example, a particular simulation data model 124 may be configured to present an analysis of the effect of changing the interest rate for a particular credit card. The results of such a model may specify the expected mean and distribution of credit-card balances maintained by customers in response to the change, perhaps broken down according to a variety of demographic criteria. Such information may be useful for a credit-card provider to determine the expected effect on revenue if the interest rate charged to customers, or to a selected subset of customers, is changed.

FIG. 1B also provides a number of examples of the sources 112 that provide information to the database 100 in the specific context of credit-card functions. For example, the “Acct Transfer Files” source may provide pointer data between accounts to indicate that relevant information should be transferred between those accounts; this is useful for maintaining continuity of information for customers who are assigned new accounts in response to reports that credit cards have been lost and/or stolen. The “Cardholder Flap File” source may provide data specifying how accounts are to be maintained, including such information as how to price transactions for individual credit cardholders. The “Posted Monetary File” source may provide data specifying transactional information for each of the credit accounts. The “Additional Names File” source may provide data specifying the identities of individuals authorized to execute transactions with a credit account, although not having financial responsibility for the account. The “Card Issuance Forecast Files” and “CIU” sources may provide data regarding the materials availability and needs for upcoming card issuances; additional details regarding such functions is provided in copending, commonly assigned U.S. pat. appl. Ser. No. __/___,___, entitled “SYSTEM FOR FORECASTING AMOUNTS OF MATERIALS NEEDED FOR CREDIT CARD REISSUE,” filed Jun. 14, 2002 by Sharon Hogan and John Coleman (Attorney Docket No. 020375-005200US), the entire disclosure of which is herein incorporated by reference for all purposes. The “Security Masterfile” source may provide data generated as part of the investigation when cards are reported lost and/or stolen. The “Bonbase File” source may provide data related to bonus programs, such as frequent-flier points awarded. The “Collection Masterfile” source may provide data related to an account when it is put into a delinquent collections status. The “Cardholder Masterfile” source may provide data for each individual cardholder, such as applicable interest rate, risk-related or marketing-related scores, etc. The “MSR” source may provide statement-record data. The “Evolving Database” source may provide data related to managing accounts, additional details of which are provided in copending, commonly assigned U.S. pat. appl. Ser. No. 10/091,653, entitled “SYSTEM AND METHOD FOR MANAGING ACCOUNTS,” filed Mar. 5, 2002 by Robert C. Guy et al., the entire disclosure of which is herein incorporated by reference for all purposes. These specific sources are provided only as illustrations of the type of sources that may be provided in embodiments of the invention and are not intended to limit the scope of the invention. Still other sources of information may be used to provide data to the database 100, including, for example a source that provides multiple addressing for cardholders such as described in copending, commonly assigned U.S. pat. appl. Ser. No. 10,119,205, entitled “SYSTEM AND METHOD FOR MANAGING ACCOUNT ADDRESSES,” filed Apr. 8, 2002 by Heather Bruce et al., the entire disclosure of which is herein incorporated by reference for all purposes.

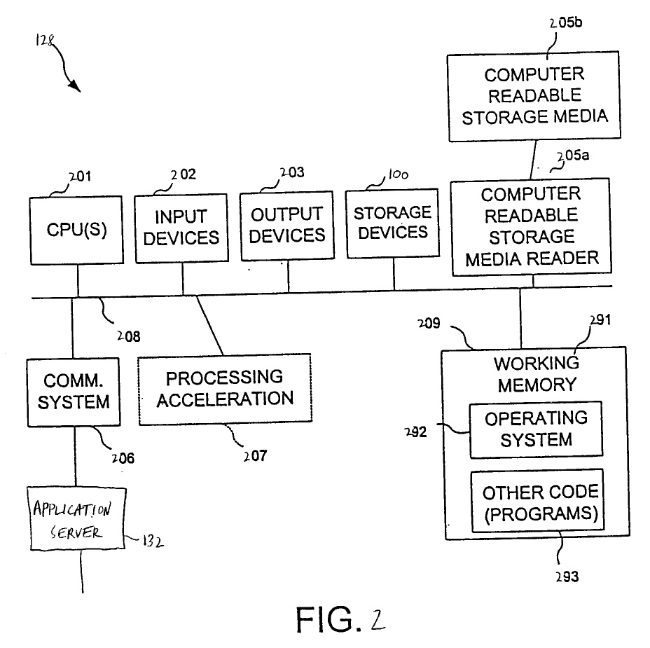

FIG. 2 provides a schematic illustration of a computer system on which the methods of the invention may be implemented. While the figure shows a computer system that may be used to perform the functions of the database server 128, a similarly configured computer system may also be used for the application server 132 and/or the web server 136. This figure broadly illustrates how individual system elements for the database server may be implemented in a separated or more integrated manner. The database server 128 is shown comprised of hardware elements that are electrically coupled via bus 208, including a processor 201, one or more input devices 202, one or more storage devices 204, a computer-readable storage media reader 205a, a communications system 206, a processing acceleration unit 207 such as a digital signal processor (“DSP”) or special-purpose processor, and a memory 209. The computer-readable storage media reader 205a is further connected to a computer-readable storage medium 205b, the combination comprehensively representing remote, local, fixed, and/or removable storage devices plus storage media for temporarily and/or more permanently containing computer-readable information.

The database 100 is shown electrically connected to the hardware elements of the database server by the bus 208. While the database is shown schematically in FIGS. 1A, 1B, and 2 as a single structure, it is to be understood that more generally the database may comprise a distributed database by being stored across multiple storage devices. In some embodiments, the database may have one or more dedicated communications links 212 with the financial-transaction-data sources 112, but the system may alternatively use communications system 206 to receive information from the sources. The communications system 206 is also configured as shown to effect communications as needed with the application server 132. It thus receives instructions directing the database server 128 to extract information from the database 100 in accordance with queries as described below. In addition to providing such infrastructure communications links internal to the system, the communications system 206 may also provide a connection to other networks and may comprise a wired, wireless, modem, and/or other type of interfacing connection.

The database server 128 also comprises software elements, shown as being currently located within working memory 491, including an operating system 492 and other code 493, such as a program designed to implement methods of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed. Specifically, where a structure similar to that shown in FIG. 2 is used for the application server 132 and/or web server 136, the element corresponding to the communications system 206 permits communications between the other elements shown in FIG. 1B.

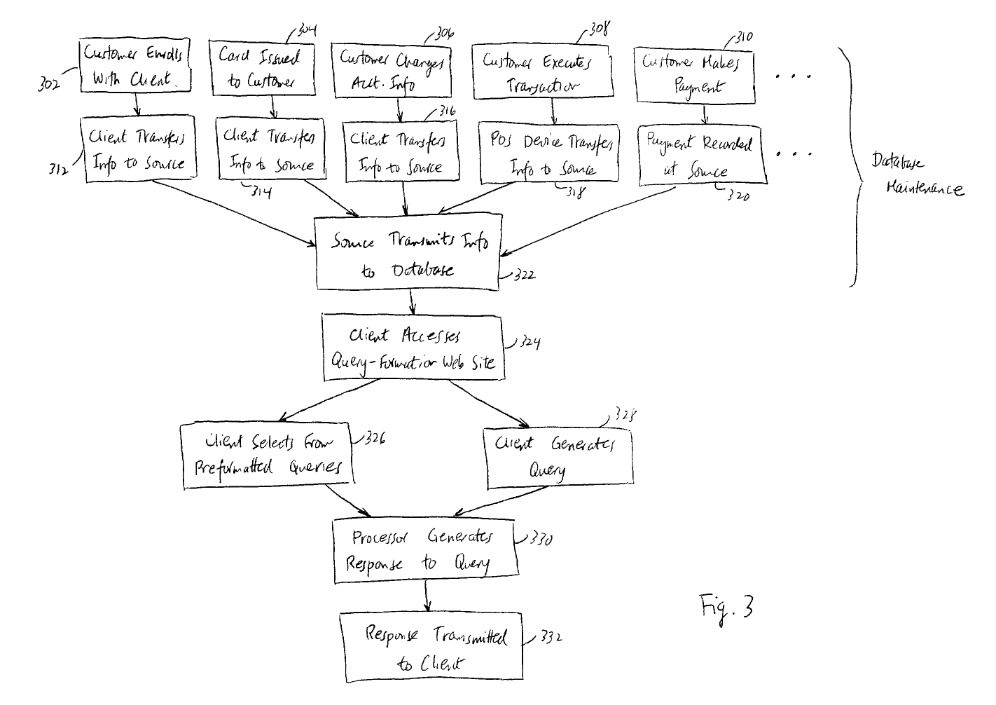

FIG. 3 provides a flow diagram illustrating a variety of different methods that may be performed with the structural arrangement described above in accordance with certain embodiments of the invention. Several examples are provided to illustrate how the database 100 is maintained by collecting information from different types of financial-transaction-data sources 112 for a credit-card customer 108 having a credit relationship with a particular financial-service provider 104. In many of these examples, the financial-transaction-data sources correspond to computer systems in different departments of an organization that handles many functions on behalf of the financial-service provider. Such an organization is sometimes referred to herein as a “financial-processing organization.” Thus, at block 302, the customer initially enrolls with the financial-service provider 104. During such enrollment, information regarding the customer is collected, such as his name and address, his annual income, a summary of his debts, his credit history, etc. This information is transferred by the financial-service provider 104 to a financial-transaction-data source 112, which may be a computer within a department of the financial-processing organization designated to collect credit-card information. In one embodiment, the source 112 to which this information is provided is the “Cardholder Masterfile” source described with respect to FIG. 1B.

This financial-service provider 104 may then arrange for a credit card to be issued to the customer 108 at block 324. The fact that the credit card has been issued is conveyed to another financial-transaction-data source 112 at block 314. This source 112 may be the same computer within the same department of the organization or may be a different source 112, such as a computer within a separate card-issuance department within the financial-processing organization. In one embodiment, the source 112 to which this information is provided is the “CIU” source described with respect to FIG. 1B.

During the time that the customer 108 uses the credit card, he may provide a change in account information at some time, as noted at block 306. For example, the customer 108 may move his residence and provide the financial-service provider 104 with an updated address. Alternatively, the customer 108 may change occupations and provide this information to the financial-service provider 104. At block 316, the financial-service provider 104 transfers this updated information to a financial-transaction-data source 112, which might correspond to one of the previous computers within the financial-processing organization, or might correspond to a computer in yet a different department within the financial-processing organization designated for handling customer updates. In one embodiment, the source 112 to which this information is provided is the “Cardholder Masterfile” source described with respect to FIG. 1B.

Block 308 corresponds to an instance in which the customer 108 actually executes a transaction with the credit card. In this instance, a point-of-sale device such as described above may automatically transfer information defining characteristics of the transaction to a financial-transaction-data source 112 at block 318. This source may correspond to a computer in one of the previously described departments or in still another department of the financial-processing organization. In one embodiment, the source 112 to which this information is provided is the “Posted Monetary File” source described with respect to FIG. 1B.

Block 310 corresponds to an instance in which the customer 108 makes a payment towards his credit account. This payment may be made by mail to a department within the financial-processing organization, or even to a separate payment-collection organization, either of which acts as a financial-transaction-data source 112 that receives and records the payment. Alternatively, the payment could be made electronically, such as directly by the customer 108 to a computer in the department or organization charged with processing the payments. Such a payment is thus received by the financial-transaction-data source at block 320. In one embodiment, the source 112 to which this information is provided is the “Cardholder Masterfile” source and/or Posted Monetary source described with respect to FIG. 1B.

Still other types of information may be collected by different financial-transaction-data sources in the example where the financial-service provider is a credit-card company. As is evident from the above description, a single financial-processing organization may conveniently implement different types of functions and collect the associated financial-transaction data among a variety of separate departments. Such departmentalization of the functions is especially appropriate where the number of consumers is sufficiently large that it would be inefficient to concentrate the functions. In addition, the financial-processing organization may be responsible for performing such functions for several credit-card companies, enhancing the efficiencies resulting from departmentalization by function. Also, while the examples have used illustrations for processing credit-card-related transactions, similar types of information may be collected in other embodiments for other types of financial-service providers 104.

Regardless of how the information is collected and made available to the financial-transaction-data source 112, the source 112 transmits the relevant data to the database 100 at block 322. The financial-transaction data may be preformatted prior to transmission to the database 100. The database 100 is thus maintained through application of functions such as indicated by blocks 302-322, with information periodically being collected from multiple customers 108 associated with multiple financial-service providers 104. In another embodiment, the database 100 may be maintained through continuous application of such function, with information being collected continually from the customers 108.

The database 100 may then be accessed and used by any of the financial-service providers 104 to extract information or perform any of the other functions 140 described with respect to FIG. 1B. In one embodiment, the database is freely searchable and may be tied to authorization and scoring functions. At block 324, the financial-service provider 104 accesses a query-submission web site through the web server 136. A selection may be made from a set of preformatted queries at block 336 or the financial-service provider 104 may use tools provided for generating its own queries at block 328. The selected or constructed query is transmitted by the application server 132 to the database server 128, which acts to generate a response to the query from the information in the database 100 at block 330. In certain embodiments, generation of this response comprises correlating financial-transaction data provided from at least two distinct financial-transaction-data sources 112, although in other embodiments a single financial-transaction-data source 112 may be used. In other embodiments, generation of the response further comprises correlating financial-transaction data associated with a plurality of financial-service providers, usually including the financial-service provider initiating the query, although this is not a requirement.

The response to the query is transmitted at block 332 by the application server 132 to the web server 136 for subsequent consideration and/or use by the financial-service provider. The response may take a variety of different forms, including as a file containing a list of all database records that satisfy the query. The generation and processing of queries may proceed differently in various alternative embodiments. For example, rather than simply request that a particular query be processed at block 324, the financial-service provider may specify that certain queries be executed at regular periodic intervals. The recurrent execution of such regular queries permits the information in the database 100 to be used in generating reports periodically, such as weekly, monthly, or quarterly.

In addition, in some embodiments the results of the query may be transmitted back to sources within the financial-processing organization for further action on behalf of the financial-service provider. Such query-feedback functions may be classified according to a number of different criteria. In some embodiments, the query feedback may comprise auditing information. For example, a regular query may be established to monitor accounts for interest rates. In terms of FIG. 1B, such a query may rely on a “Cardmaster Information” data model 124, which permits accessing interest rates for each of the credit accounts. If the result of the query identifies accounts that have interest rates of 0%, for example, the result may be taken as an indication that the interest rate is incorrect and should be reset at, say, 19%. Accordingly, this information is fed back to the “Cardholder Masterfile” source in FIG. 1B so that the interest rate for those accounts may be corrected and, perhaps, an explanatory letter forwarded to the affected customers.

In other embodiments, the query feedback may comprise marketing information. For example, suppose a query is generated to identify a particular group of credit-card holders, say those who have rented an automobile from a specific rental agency in the last two months. Such a query might rely on the “Transaction” data model 124 discussed in connection with FIG. 1B. The results of this query may be transmitted to the department responsible for sending periodic statements to the cardholders, together with an instruction to include an advertising insert for that rental agency for those identified by the query result. In terms of the sources described with respect to FIG. 1B, for example, the query feedback may be returned to the “MSR” source. In one embodiment, the advertising insert may include a coupon and a subsequent query may be used to evaluate the success of the set of inserts by determining how many such coupons were actually used; in some instances, each coupon may include a unique identifier so that the subsequent query may identify specifically which coupons were used.

In still other embodiments, the query feedback may comprise risk information. For example, suppose a financial-service provider wishes to assess the risk that fraudulent charges may be made during the December holiday season. A query may be generated to evaluate risk scores based on merchandise types and on time of year. In terms of the data models 124 described with respect to FIG. 1B, such a query might use the “Risk” model. The results, which could take the form, say, of identifying jewelry sales as being of high risk, could then be fed back to one of the sources so that appropriate warnings could be issued to jewelry stores, perhaps requiring that they engage in stricter identity-verification procedures than are usually required. In a particular embodiment, the source to which this information is fed back includes account processing parameters that control authorization processing.

The invention also permits simulations to be performed in some embodiments. Such simulations may fall into the auditing, marketing, and risk-analysis classes described above. For example, within the credit-card example, one auditing-type simulation that may be performed assesses the effect of increasing credit limits over an entire credit portfolio to determine the resulting contingent liability of the credit provider. An example of a marketing-type simulation evaluates the effect of changing a bonus program, such as a frequent-flyer program, on usage of the credit cards by customers. Such a simulation could use a model relating usage scores to various incentive programs to determine the effect of the proposed change. An example of a risk-type simulation assesses the effect of changing credit-approval criteria so that more or fewer customers with certain credit scores might be given a certain level of credit. The effect of such a change is then evaluated by considering, for example, the effect on total revenue considering both the change in number of customers and the change is risk exposure that result from the proposed change. Accordingly, the availability of such simulations permits the financial-service providers to consider revising their policies in any number of respects and to forecast the effect of such changes as a factor in determining whether to implement the policy change.

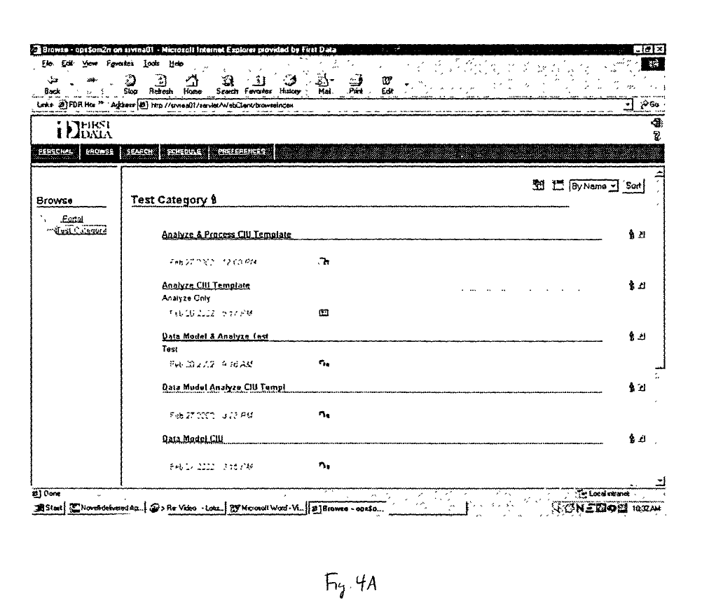

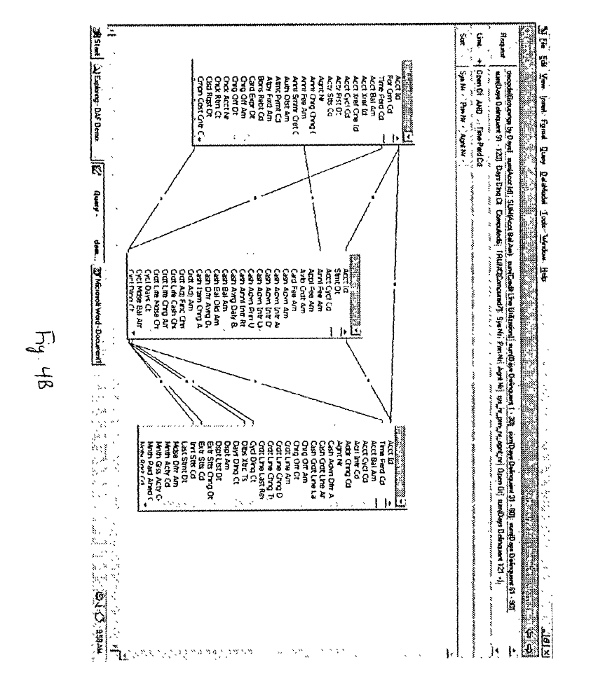

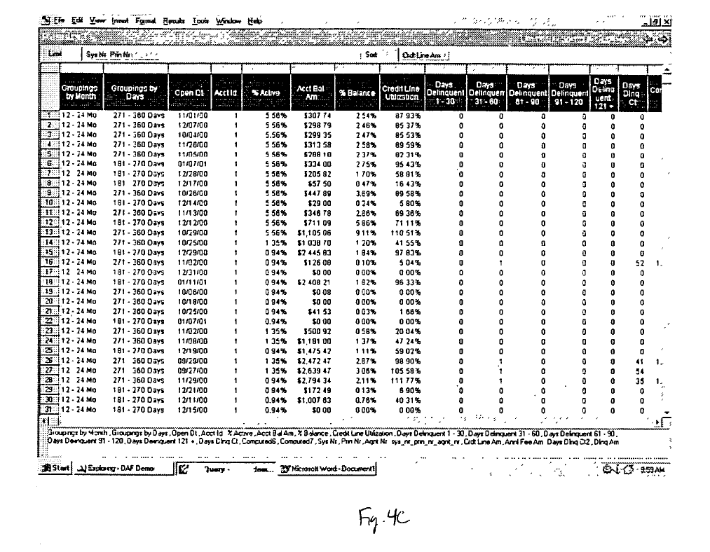

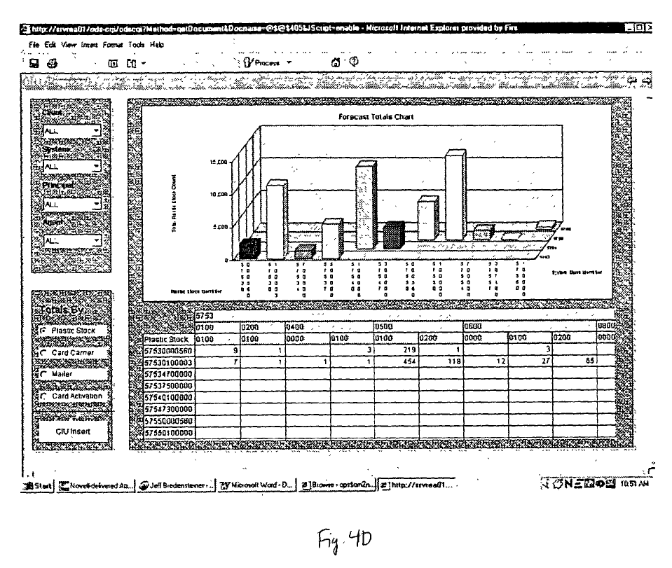

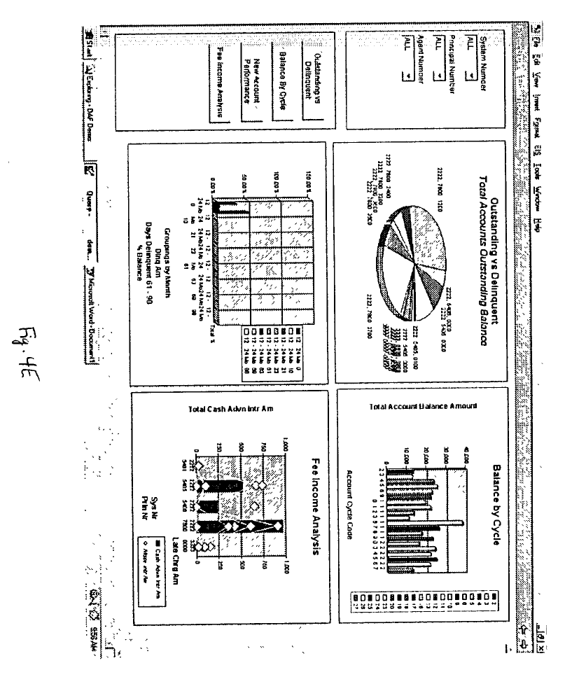

FIGS. 4A-4E provide exemplary screen shots from an implementation of a particular embodiment of the invention. In this implementation, a web server 136 is used to provide a web-browser based interface with the financial-service provider to generate queries and receive the results of the queries. FIG. 4A provides an example of a screen that may be presented to a user affiliated with the financial-service provider after authentication by a security sign-on process, such as through confirmation of a password. The different selections provided on the screen represent features and/or functions that are available for that particular user. The specific selection provided may vary by user in some embodiments; for example, some users may be permitted only to view data, some may be permitted to view data and create queries, and others may have limited access only to certain data models, etc. The list of available items also includes documents that have been published to that user, such as reports, charts, and/or graphs that have been created by another user and sent to the viewing user. The available data models correspond generally to the “CIU” data models discussed with respect to FIG. 1B. As explained with respect to FIG. 1B, each of the data models limits the available fields to those relevant for the types of queries anticipated. Accordingly, the data models provide a template, such as shown in FIG. 4B, from which different field parameters may be selected in forming the query.

FIG. 4B also shows an example of such a query. The query may be retrieved from one of the preformatted queries or may be generated directly by the user using tools for generating the query. In the illustrated embodiment, the query format is appropriate for a relational database in which entries in distinct fields may be related with each other. Each of the fields is presented with a table of entries, which may be clicked and dragged by a user to a work area for forming a query. The query itself is shown in FIG. 4B as having three parts. The first part 406 specifies the basic data attributes that the results for the query should satisfy. The second part 412 provides limiting conditions to narrow the scope of the results. The third part 418 provides sorting criteria specifying how the results of the query should be organized for presentation. In the illustrated example, the query is constructed using a relational database, although in other embodiments it may be formed with other types of databases, including object-oriented and other types of databases known to those of skill in the art.

FIG. 4C provides an example of a result of a query after execution with respect to the database. In this example, the result comprises a file listing all entries within the database that meet the criteria specified by the query. The specific example is one that might be provided to a credit-card provider and includes such information as account balance for each of the customers meeting the query criteria, as well as the fraction of their credit limits that such balances represent, the level of credit-line utilization, and a binning of delinquencies according to the length of the delinquency. The generation of this response thus includes correlating financial-transaction data from multiple sources—information is used, for example, from a source of individual-transaction information, a source of enrollment information, and a source of payment information.

FIG. 4D provides an example of a graphical format that may be used for presenting the result of a query. In this example, the query requests that a simulation be performed to forecast levels of plastic stock that will be available to the card-issuance unit of a financial-processing organization. The bar graph summarizes the stock levels available for different types of stock at different time periods, based on current stock levels and expected number of cards to be issued based on past patterns of card issuance. Accordingly, this example also includes correlating financial-transaction data from multiple sources—information is used, for example, from a source of stock-inventory information and a source of enrollment information.

FIG. 4E provides an example of a multiple-graph display summarizing the results of a more complex query. The example illustrates that a variety of types of graphical displays may be used, individually or in combination, to summarize results. In this instance, the results are also derived for a query related to the operations of a credit-card company. The upper left quadrant includes a pie chart comparing outstanding and delinquent account balances; the upper right quadrant includes a bar graph showing account balance levels as they vary by day of the month over a billing cycle; the lower left quadrant shows a bar graph summarizing the percentage of accounts meeting certain delinquent-status criteria; and the lower right quadrant provides a combined bar and line graph summarizing the amount advanced to customers and the late charges accrued. Like the previous examples, the particular combinations of information used in generating such an analysis are derived from different financial-transaction-data sources, with correlations becoming evident between those sources. For example, data from at least sources of enrollment information, individual-transaction information, and payment information are correlated to produce the results shown in FIG. 4E.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for managing information comprising:
maintaining financial-transaction data collected from a plurality of distinct sources, each such source providing financial-transaction data associated with a plurality of financial-service providers;
receiving a query from at least one of the financial-service providers;
generating a response to the query, including correlating financial-transaction data provided from a first of the distinct sources with financial-transaction data provided from a second of the distinct sources; and
returning the response to at least one of the plurality of distinct sources.

2. The method recited in claim 1 further comprising transmitting an electronic file corresponding to the response to the at least one of the financial-service providers.

3. The method recited in claim 1 wherein the query comprises at least one of an audit-based query, a marketing-based query, and a risk-based query.

4. The method recited in claim 1 wherein the query is one of a plurality of preformatted queries supplied to the at least one of the financial-service providers.

5. The method recited in claim 1 wherein receiving the query comprises receiving the query from an Internet web interface.

6. The method recited in claim 1 wherein the query identifies at least one predetermined time for execution and generating the response comprises generating the response with financial-transaction data as of the at least one predetermined time.

7. A method for managing information comprising:
maintaining financial-transaction data collected from a plurality of distinct sources, each such source providing financial-transaction data associated with a plurality of financial-service providers;
receiving a query from at least one of the financial-service providers;
performing a simulation in accordance with the query; and
returning a result of the simulation to the one of the financial-service providers.

8. The method recited in claim 7 wherein the query comprises at least one of an audit-based query, a marketing-based query, and a risk-based query.

9. The method recited in claim 7 wherein the query is one of a plurality of preformatted queries supplied to the at least one of the financial-service providers.

10. The method recited in claim 7 wherein receiving the query comprises receiving the query from an Internet web interface.

11. The method recited in claim 7 further comprising comparing the result of the simulation with nonsimulated data.

12. A computer-readable storage medium having a computer-readable program embodied therein for directing operation of a computer system including a communications device, a processor, and a storage device, wherein the computer-readable program includes instructions for operating the computer system to manage information in accordance with the following:
maintaining financial-transaction data collected from a plurality of distinct sources on the storage device, each such source providing financial-transaction data associated with a plurality of financial-service providers;
receiving a query from at least one of the financial-service providers with the communications device;
generating a response to the query with the processor, including correlating financial-transaction provided from a first of the distinct sources with financial-transaction data provided from a second of the distinct sources; and
returning the response to at least one of the plurality of distinct sources with the communications device.

13. The computer-readable storage medium recited in claim 12 wherein the query comprises at least one of an audit-based query, a marketing-based query, and a risk-based query.

14. The computer-readable storage medium recited in claim 12 wherein the query is one of a plurality of preformatted queries supplied to the at least one of the financial-service providers with the communications device.

15. The computer-readable storage medium recited in claim 12 wherein the query identifies at least one predetermined time for execution and generating the response comprises generating the response with financial-transaction data as of the at least one predetermined time.

16. A computer-readable storage medium having a computer-readable program embodied therein for directing operation of a computer system including a communications device, a processor, and a storage device, wherein the computer-readable program includes instructions for operating the computer system to manage information in accordance with the following:
maintaining financial-transaction data collected from a plurality of distinct sources on the storage device, each such source providing financial-transaction data associated with a plurality of financial-service providers;
receiving a query from at least one of the financial-service providers with the communications device;
performing a simulation in accordance with the query with the processor; and
returning a result of the simulation to the one of the financial-service providers with the communications device.

17. The method recited in claim 16 wherein the query comprises at least one of an audit-based query, a marketing-based query, and a risk-based query.

18. The method recited in claim 16 wherein the query is one of a plurality of preformatted queries supplied to the at least one of the financial-service providers.

19. The computer system recited in claim 16 wherein receiving the query comprises receiving the query from an Internet web interface.
